(19) United States
(12) Patent Application Publication
(10) Pub. No.: US 2017/0277343 A1
(43) Pub. Date: Sep. 28, 2017

(54) ELECTRONIC-BOOK READER DEVICE AND NON-TRANSITORY COMPUTER-READABLE RECORDING MEDIUM HAVING STORED THEREIN A DISPLAY CONTROL PROGRAM

(71) Applicant: FUJITSU LIMITED, Kawasaki-shi (JP)

(72) Inventor: Mitsunori Hotta, Kanagawa (JP)

(73) Assignee: FUJITSU LIMITED, Kawasaki-shi (JP)

(21) Appl. No.: 15/442,167

(22) Filed: Feb. 24, 2017

(30) Foreign Application Priority Data
Mar. 28, 2016 (JP) 2016-063883

(51) Int. Cl. G06F 3/041; G06F 3/0346; G06F 3/0483

(52) U.S. Cl. CPC G06F 3/0416; G06F 3/0483; G06F 3/0346; G06F 2203/04105

(57) ABSTRACT

An electronic-book reader device includes a screen that displays a page image of an electronic book; a first sensor disposed on a side face of the electronic-book reader device; a second sensor disposed on a reverse face of the screen of the electronic-book reader device; a determiner that determines a rate of switching display of a plurality of the page images using an amount of input operation via the first sensor and an amount of input operation via the second sensor; and a display controller that carries out continuous page-turning display on the screen by displaying the plurality of page images being successively switched at the rate determined by the determiner. This configuration makes the reader possible to turn pages, feeling as if reading a paper-medium book.

### CROSS-REFERENCE TO RELATED APPLICATION

This application is based upon and claims the benefit of priority of the prior Japanese Patent application No. 2016-063883, filed on Mar. 28, 2016, the entire contents of which are incorporated herein by reference.

### FIELD

The embodiment discussed herein is directed to an electronic-book reader device and a non-transitory computer-readable recording medium having stored therein a display control program.

### BACKGROUND

In recent years, more people have read electronic books (hereinafter abbreviated “e-books”) on a mobile terminal device in place of paper-medium books.

On such a mobile terminal device, a user turns pages on the page image displayed on the touch panel by, for example, sliding the finger of the user on the surface of the touch panel or pressing the button to turn pages.

### PRIOR ART REFERENCE

### Patent Literature

[Patent Literature 1] Japanese Laid-open Patent Publication No. 7-319899
[Patent Literature 2] Japanese Laid-open Patent Publication No. 2009-200665
[Patent Literature 3] Japanese Laid-open Patent Publication No. 2003-345492

However, sliding the finger of the user on the surface of the touch panel or pressing the button to turn pages on a traditional mobile terminal device makes the user uncomfortable because being largely different from turning pages of a traditional paper-medium book.

### SUMMARY

According to an aspect of the embodiment, an electronic-book reader device includes a screen that displays a page image of an electronic book; a first sensor that is disposed on a side face of the electronic-book reader device; a second sensor that is disposed on a reverse face of the screen of the electronic-book reader device; a determiner that determines a rate of switching display of a plurality of the page images using an amount of input operation via the first sensor and an amount of input operation via the second sensor; and a display controller that carries out continuous page-turning display on the screen by displaying the plurality of page images being successively switched at the rate determined by the determiner.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an isometric view illustrating an aspect of the top face of a mobile terminal functioning as an example of an electronic-book reader device according to a first embodiment;

FIG. 2 is a block diagram schematically illustrating an example of the hardware configuration of an electronic-book reader device of the first embodiment;

FIG. 3 is a partial isometric view illustrating a right-side touch panel of a mobile terminal of a first embodiment;

FIGS. 4A and 4B are diagrams comparing examples of a mobile terminal of the first embodiment with an actual book;

FIG. 5 is an isometric view illustrating an example of an input operation on a mobile terminal of the first embodiment;

FIG. 6 is an isometric view illustrating an example of the aspect of the back face of a mobile terminal of the first embodiment;

FIG. 7 is an isometric view illustrating a position of an acceleration sensor of a mobile terminal of the first embodiment;

FIG. 8 is a diagram illustrating a flapping action on a mobile terminal of the first embodiment;

FIGS. 9A-9C are diagrams illustrating examples of displaying an electronic-book on the main touch panel of a mobile terminal of the first embodiment;

FIGS. 10A and 10B are diagrams illustrating examples of turning pages of an electronic-book on the main touch panel of a mobile terminal of the first embodiment;

FIG. 11 is a diagram illustrating an example of calculating a rate of turning pages of a display switching rate determiner of a mobile terminal of the first embodiment;

FIGS. 12A and 12B are a flow diagram illustrating a succession of procedural steps performed for continuous turning pages on an example of a mobile terminal of the first embodiment;

FIGS. 13A and 13B are a flow diagram illustrating a succession of procedural steps performed for turning a single page on an example of a mobile terminal of the first embodiment;

FIGS. 14A and 14B are partial isometric views illustrating examples of a right-side touch panel on a mobile terminal according to a modification to the first embodiment; and

FIGS. 15A to 15C are isometric views illustrating examples of the aspect of the back face of a mobile terminal of a modification to the first embodiment.

### DESCRIPTION OF EMBODIMENT(S)

Hereinafter, an electronic-book reader device and a method of display control according to a first embodiment will now be detailed with reference to accompanying drawings. The following first embodiment is exemplary and has no intention to exclude various modifications and applications of techniques not referred in the first embodiment. In other words, various changes and modifications can be suggested without departing from the spirit of the first embodiment. The drawings do not illustrate therein all the functions and elements included in the embodiment and may include additional functions and elements to those illustrated in the accompanying drawings.

(A) Configuration:

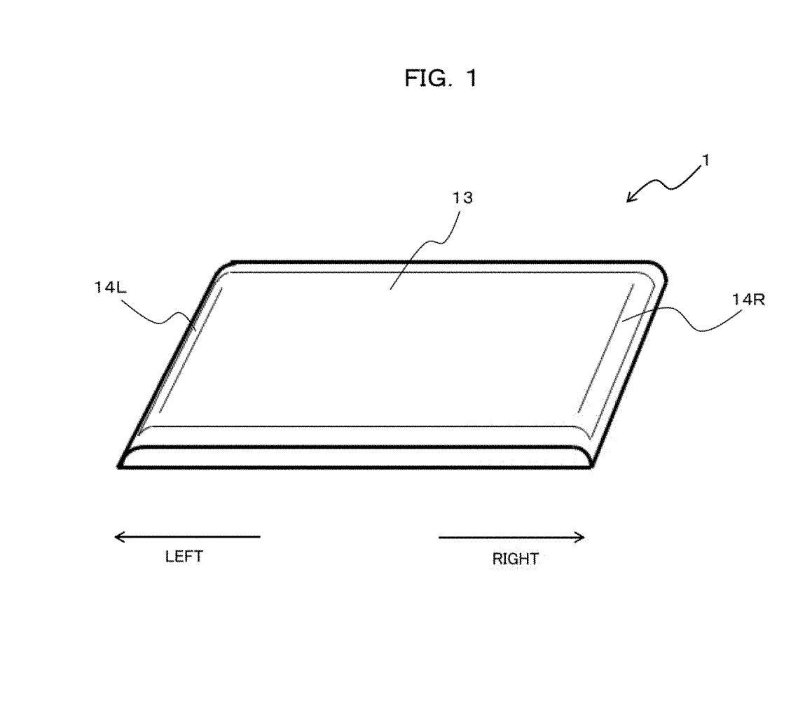

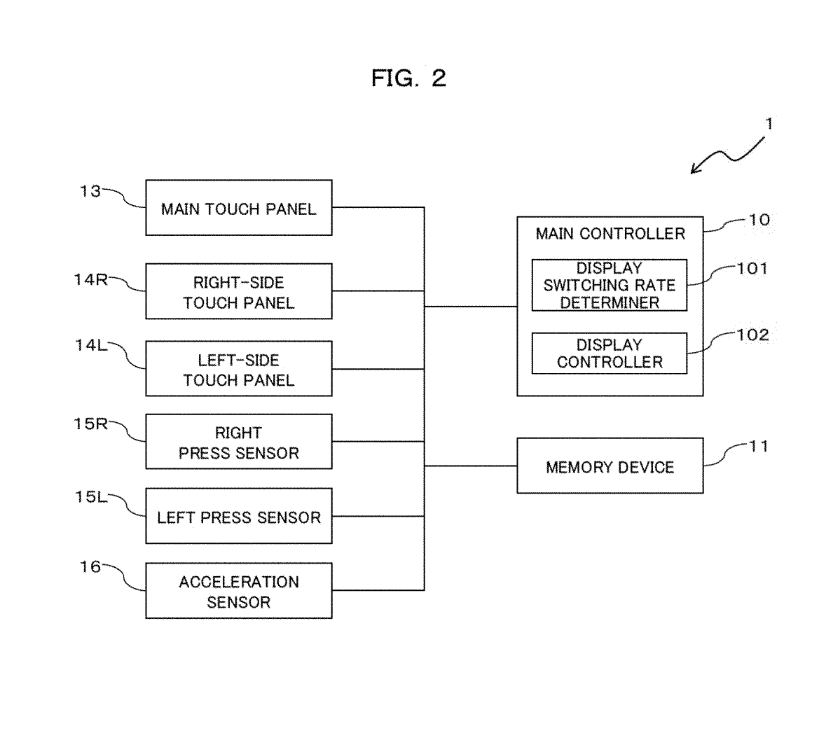

FIG. 1 is an isometric view illustrating an aspect on the top face of a mobile terminal 1 functioning as an example of an electronic-book (hereinafter abbreviated to e-book) reader device according to a first embodiment; and FIG. 2 is a block diagram schematically illustrating an example of the hardware configuration of the e-book reader device.

The mobile terminal 1 is an information processing apparatus portable by the user and takes the shape of, as illustrated in FIG. 1, a rectangular plate.

As illustrated in FIG. 2, the mobile terminal 1 includes a main controller 10, a memory device 11, a main touch panel 13, a right-side touch panel 14R, a left-side touch panel 14L, a right press sensor 15R, a left press sensor 15L, and acceleration sensor 16.

The main touch panel 13 is a touch panel that includes a screen such as a Liquid Crystal Display (LCD) integrated with a function of a position input device such as a touch pad.

As illustrated in FIG. 1, the main touch panel 13 is in a rectangular form and forms one surface of the mobile terminal 1. Hereinafter, the surface with the main touch panel 13 of the mobile terminal 1 is referred to as a top face or a top-side face.

The mobile terminal 1 displays an image of a book on the main touch panel 13. Accordingly, the main touch panel 13 corresponds to the screen that displays a page image of an e-book.

The mobile terminal 1 further includes the right-side touch panel 14R arranged along one of the short sides of the main touch panel 13 and the left-side touch panel 14L disposed along the other short side.

Hereinafter, the side with the right-side touch panel 14R and the side with the left-side touch panel 14L seen from the above the main touch panel 13 are referred to as the right side and the left side of the mobile terminal 1, respectively.

The right-side touch panel 14R and the left-side touch panel 14L are each touch panel that integrates a screen such as an LCD with a function of a position input device such as a touch pad.

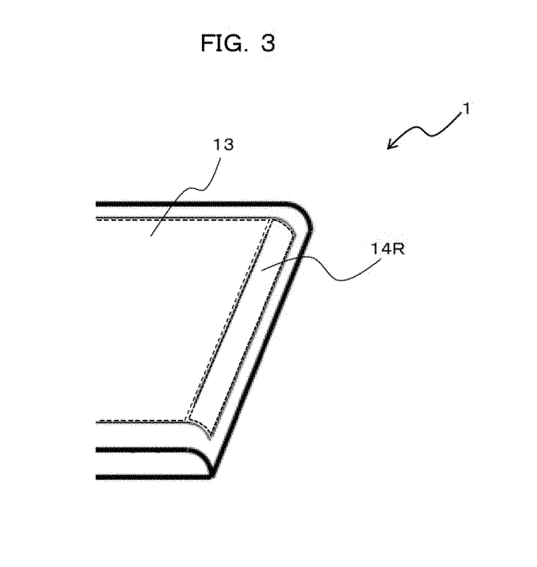

FIG. 3 is a partial isometric view illustrating the right-side touch panel 14R of the mobile terminal 1 of a first embodiment.

As illustrated in FIG. 3, the right-side touch panel 14R is disposed along the right short side of the top face of the mobile terminal 1.

The right-side touch panel 14R and the left-side touch panel 14L each have a flexible LCD and are curved along arcs having the axes parallel to the respective short sides of the mobile terminal 1 as the centers. With this configuration, the right-side touch panel 14R couples the right short side of the main touch panel 13 to the right side face of the mobile terminal 1 in an arc. Likewise, the left-side touch panel 14L couples the left short side of the main touch panel 13 to the left side face of the mobile terminal 1 in an arc.

The right-side touch panel 14R couples one side thereof to one of the short sides of the main touch panel 13 so as to be flushed with each other. This allows the right-side touch panel 14R to function as a sub display attached to the right side of the main touch panel 13.

The left-side touch panel 14L is disposed on the left side of the mobile terminal 1 likewise the right-side touch panel 14R. Accordingly, the left-side touch panel 14L is disposed along the left short side of the left side of the mobile terminal 1.

The left-side touch panel 14L couples one side thereof to one of the short sides of the main touch panel 13 so as to be flushed with each other. This allows the left-side touch panel 14L to function as a sub display attached to the left side of the main touch panel 13.

The right-side touch panel 14R and the left-side touch panel 14L also have functions of press sensors to detect an input operation from the finger of the user being in contact with the respective surfaces.

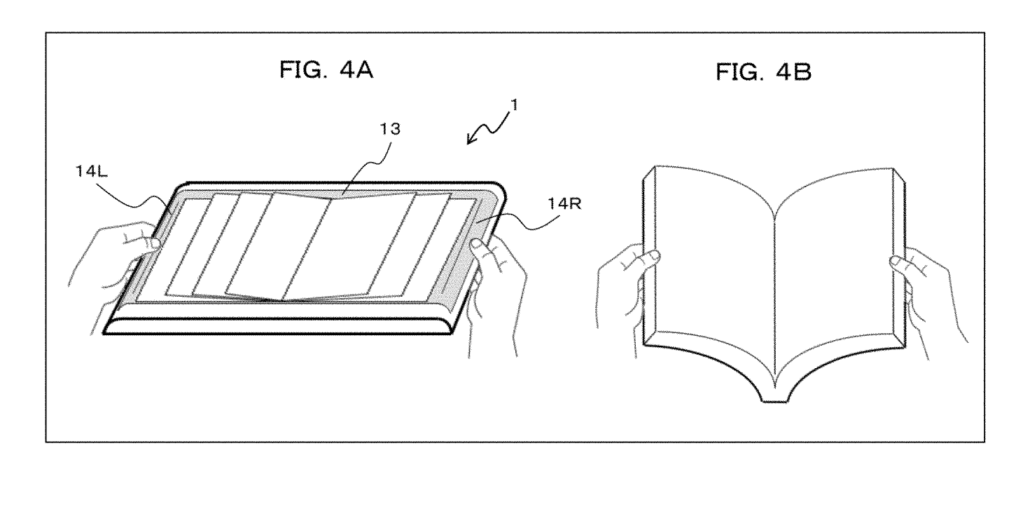

FIGS. 4A and 4B are diagrams comparing examples of the mobile terminal 1 of the first embodiment with an actual book. FIG. 4A illustrates a state where the user holds the mobile terminal 1 in order to read an e-book while FIG. 4B illustrates a state where the reader holds the mobile terminal 1 in order to read a book.

As illustrated in FIG. 4B, in reading an actual book, the reader usually holds the left- and right-side ends of the double-page spread of the book. Specifically, the user prevents the pages from being spontaneously turned by supporting the front and back covers with fingers (index finger, middle finger, ring finger, little finger) of the both hands and supporting fore edges with the both thumbs.

As illustrated in FIG. 4A, the mobile terminal 1 displays an image of an e-book in a state of a double-page spread on the main touch panel 13 and the operator (user) reads (browses) the image of the book displayed on the main touch panel 13.

The operator holds the left and right side portions of the mobile terminal 1. Specifically, the user supports the back face of the mobile terminal 1 with fingers (index finger, middle finger, ring finger, little finger) of the both hands and keeps the right thumb and the left thumb being in contact with the right-side touch panel 14R and the left-side touch panel 14L, respectively.

This means that the back face of the mobile terminal 1 corresponds to the front and back covers of an actual book, and the right-side touch panel 14R and the left-side touch panel 14L correspond to the fore edges of an actual book.

Hereinafter, a state where the operator holds the mobile terminal 1 as illustrated in FIG. 4A is sometimes referred to as a reading holding state.

Switching the page currently displayed to the next page of a book being read is referred to as turning a page. The turning a page is not limited to turning pages of an actual book but includes a process of switching a page currently being displayed of an e-book to the next page.

When the reader is to continuously turn multiple pages of an actual book (hereinafter referred to as continuous turning pages), the reader arranges the book in such a posture that the front and back covers are on the back face (lower side) and the pages of the double-page spread directs top face (upper side). Under this posture of the book, the reader prevents the pages of the book from being spontaneously turned by supporting fore edges formed of multiple pages with the cushion of the right thumb.

When continuous turning pages from the right to the left, the operator presses (presses the back face) the right-side page from the back face (having the front and back convers, bottom side) to the top face (having pages; top face) with the index finger, the middle finger, the ring finger, and/or a little finger of the right hand.

At this time, by leaving (isolating) the right thumb touching the fore edges from the fore edges (thumb isolating), the operator successively releases pages pressed by the right thumb and continuously turns the pages.

The operator adjusts an amount of turning pages through adjusting an amount of isolating the tip of the right thumb from the fore edges, that is, an amount of pressure (pressing force) that the thumb applies to the fore edges on the top face of the page.

Alternatively, by shifting the right thumb touching the fore edges from the top face (upper side) of the book to the back face (lower side) (thumb shifting), the operator sometimes successively releases pages pressed by the right thumb and continuously turns the pages.

The mobile terminal 1 achieves continuous turning pages by back-face pressing, thumb isolating, and/or thumb shifting.

When turning only a single page of an actual book (hereinafter referred to as turning a single page), the operator (reader) first opens the book and arranges the book in such a posture that the front and back covers are on the back face (lower side) and a page directs top face (upper side). Under this posture of the book, the reader prevents the pages of the book from being spontaneously turned by supporting fore edges formed of multiple pages with the cushion of the right thumb.

Then the operator presses (presses the back face) the right-side page from the back face (having the front and back convers, bottom side) to the top face (having pages; top face) with the middle finger, the ring finger, and/or a little finger of the right hand.

The operator momentarily raises the book held with the right hand upwards during the above thumb isolating or thumb shifting. This process is called flapping. This urges the right-side page upwards and turns a single page.

The mobile terminal 1 achieves turning a single page through back-face pressing and/or flapping.

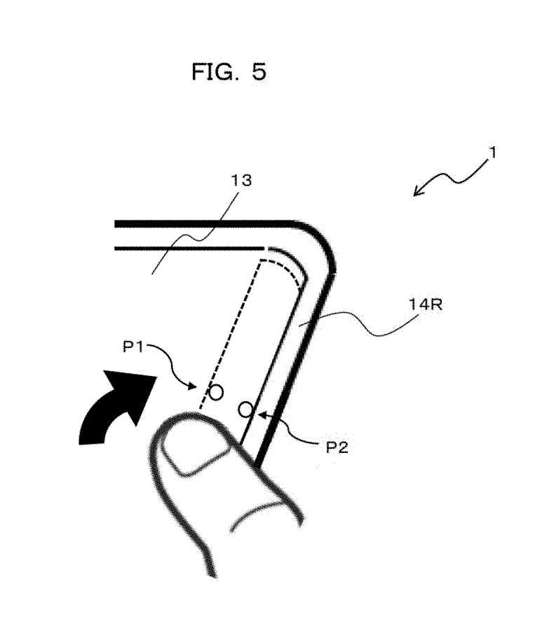

FIG. 5 is an isometric view illustrating an example of an input operation on the mobile terminal 1 of the first embodiment.

In FIG. 5, the operator makes an operation (thumb isolating) of isolating a portion near to the top face of the mobile terminal 1, that is, the tip of the thumb from the right-side touch panel 14R, under a state where the cushion of the thumb is touching the right-side touch panel 14R. This means that the operator abate pressure applied to the portion of the right-side touch panel 14R near to the top face, that is, the tip of the thumb, under a state of the cushion of the thumb keeps contact with the right-side touch panel 14R.

This operation generates, on the right-side touch panel 14R, a pressure difference between a pressure (first pressure) detected at a position (first position; see point P1 in FIG. 5) nearer to the top face of the mobile terminal 1 and a pressure (second pressure) detected at a position (second position; see point P2 in FIG. 5) nearer to the back face. The left-side touch panel 14L generates a similar pressure difference.

In the mobile terminal 1, the right-side touch panel 14R and the left-side touch panel 14L each detect a pressure difference generated between a point nearer to the top face and a point nearer to the back face.

Hereinafter, the function to detect a pressure difference generated between the first position nearer to the top face and the second position nearer to the back face on both right-side touch panel 14R and the left-side touch panel 14L is referred to as a sensor S1. A display controller 102 and a display switching rate determiner 101 that are to be detailed below detect thumb isolating of the operator on the basis of pressure difference generated between a position nearer to the top face and a position nearer to the back face on right-side touch panel 14R and/or the left-side touch panel 14L detected by the sensor S1.

Accordingly, the sensor S1 is used to detect thumb isolating that the operator makes on the right-side touch panel 14R and left-side touch panel 14L.

The operation of thumb isolating that the operator makes on the right-side touch panel 14R and the left-side touch panel 14L is regarded as an input operation to turn a page of an e-book displayed on the main touch panel 13. In other words, the thumb isolating is an input to turn a page via the right-side touch panel 14R and the left-side touch panel 14L.

The right-side touch panel 14R and the left-side touch panel 14L each detect movement of an article (specifically, the thumb of the operator) being in contact with the touch panels from a position (third position) nearer to the top face to a position (fourth position) nearer to the back face.

Hereinafter, a function to detect movement on the right-side touch panel 14R and the left-side touch panel 14L of an article being in contact with the touch panels from a position nearer to the top face to a position nearer to the back face is referred to as a sensor S2.

The display controller 102 and the display switching rate determiner 101 that are to be detailed below detect thumb shifting of the operator on the basis of movement on the right-side touch panel 14R and the left-side touch panel 14L of an article being in contact with the touch panel from a position nearer to the top face to a position nearer to the back face detected by the sensor S2.

Accordingly, the sensor S2 is used to detect thumb shifting that the operator makes on the right-side touch panel 14R and left-side touch panel 14L.

The operation of thumb shifting that the operator makes on the right-side touch panel 14R and the left-side touch panel 14L is regarded as an input operation to turn a page of an e-book displayed on the main touch panel 13. In other words, the thumb shifting is an input to turn a page via the right-side touch panel 14R and the left-side touch panel 14L.

The right press sensor 15R and the left press sensor 15L are each sensor that changes its resistance value with a contact pressure. The right press sensor 15R and the left press sensor 15L can be any known pressure sensors.

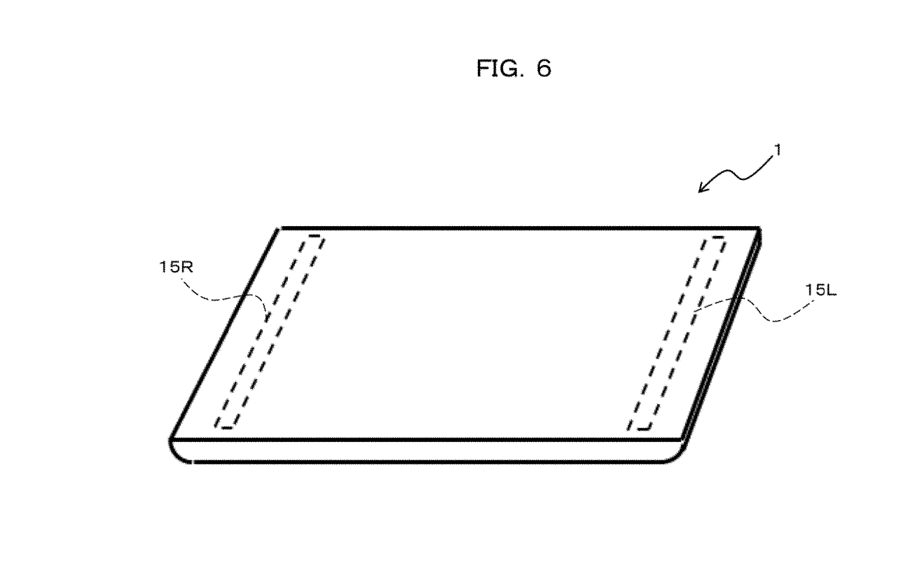

FIG. 6 is an isometric view illustrating the aspect of the back face of the mobile terminal 1 of the first embodiment.

As illustrated in FIG. 6, the right press sensor 15R is disposed on the position near to the right short side on the back face of the mobile terminal 1 in parallel to the right short side. Likewise, the left press sensor 15L is disposed on the position near to the left short side on the back face of the mobile terminal 1 in parallel to the left short side.

The right press sensor 15R and the left press sensor 15L are disposed in such positions of the back face of the mobile terminal 1 that the middle, ring, or little fingers of the operator touches the sensors 15R and 15L when the operator is holding the mobile terminal 1 for the operation.

The right press sensor 15R and the left press sensor 15L are arranged at positions being in contact with the middle, ring, little fingers of the operator during the reading holding state. This arrangement allows the right press sensor 15R and the left press sensor 15L to detect press (back-face press) from the back face of the mobile terminal 1 by the fingers of the operator during the reading holding state.

Hereinafter, the function to detect press with the right press sensor 15R and the left press sensor 15L is referred to as a sensor S3.

The display switching rate determiner 101 that is to be detailed below detects a back-face press made by the operator on the basis of the pressing pressure onto the right press sensor 15R and the left press sensor 15L, which press is detected by the sensor S3.

Accordingly, the sensor S3 is used to detect an upward press against the back face of the mobile terminal 1 by the operator.

The back-face press made by the operator against the right press sensor 15R and the left press sensor 15L is regarded as an input operation to turn a page of an e-book displayed on the main touch panel 13. In other words, the back-face press is an input to turn a page via the right press sensor 15R and the left press sensor 15L.

The acceleration sensor 16 is a sensor to detect an acceleration and specifically detects a change in posture of the mobile terminal 1 such as inclination or movement of the mobile terminal 1. The acceleration sensor 16 can be any known acceleration sensor such as one using Micro Electro Mechanical System (MEMS).

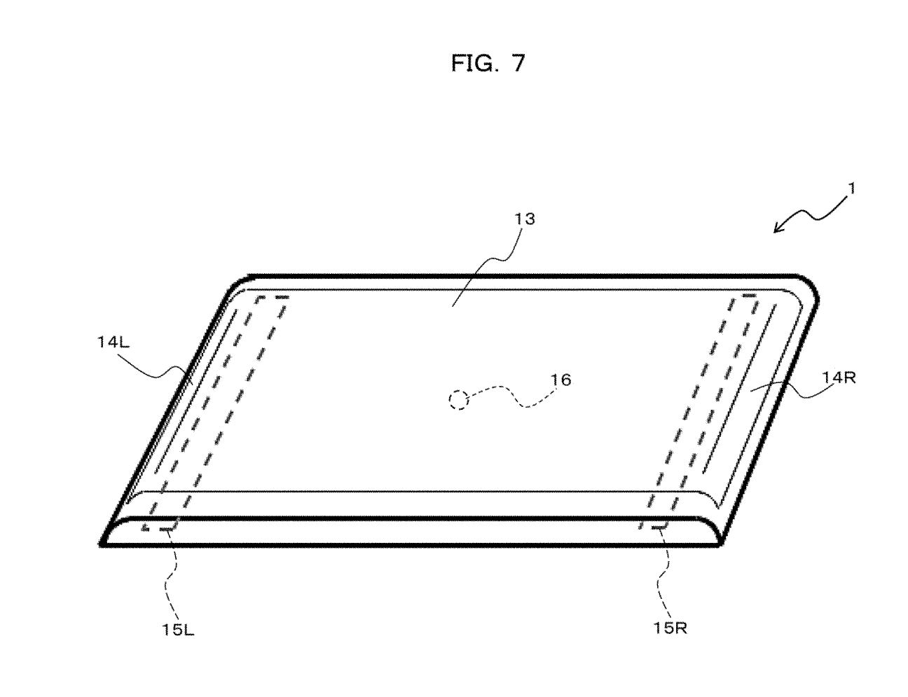

FIG. 7 is an isometric view illustrating an example of the position of the acceleration sensor 16 on the mobile terminal 1 of the first embodiment.

As illustrated in FIG. 7, the acceleration sensor 16 is disposed at a position inside the mobile terminal 1 and near to, for example, the center of the mobile terminal 1.

The acceleration sensor 16 detects changes in orientation of the right and left ends of the mobile terminal 1.

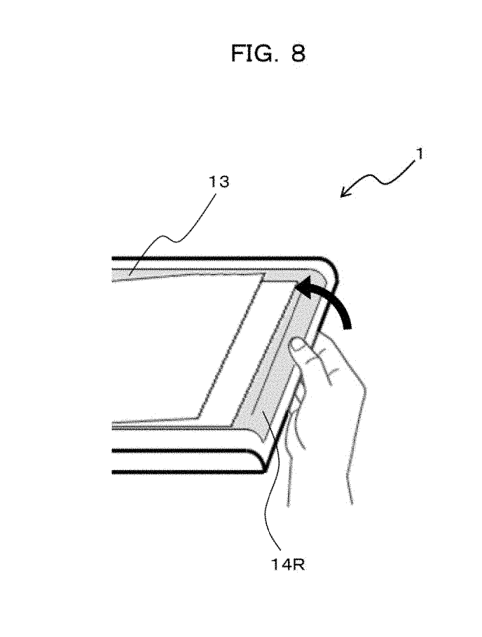

FIG. 8 is a diagram illustrating an example of flapping on the mobile terminal 1 of the first embodiment.

FIG. 8 illustrates a state where the operator is flapping the right end of the mobile terminal 1 towards the top face side of the mobile terminal 1. In other words, the operator moves the left and right ends of the mobile terminal 1 towards the top face of the mobile terminal 1 at a rate equal to or more than a predetermined rate.

The acceleration sensor 16 detects an acceleration of the mobile terminal 1 towards the top face of the mobile terminal 1 at a value equal to or more than a predetermined value. In other words, the acceleration sensor 16 detects a flapping operation that the operator momentarily raises the mobile terminal 1.

Hereinafter, a function to detect an acceleration towards a predetermined vector (e.g., towards the top face of the mobile terminal 1) equal to or more than a predetermined value is referred to as a sensor S4.

The display switching rate determiner 101 to be detailed below detects flapping by the operator on the basis of the acceleration towards the predetermined vector equal to or more than the predetermined value detected by the sensor S4.

Accordingly, the sensor S4 is used to detect flapping made by the operator of the mobile terminal 1.

A flapping operation made by the operator of the mobile terminal 1 is regarded as an input operation to turn a page of an e-book displayed on the main touch panel 13. This means that flapping is an input to turn a page via the acceleration sensor 16.

The memory device 11 is a memory including a Read Only Memory (ROM) and a Random Access Memory (RAM). In the ROM of the memory device 11, a software program to achieve the various functions of the mobile terminal 1 and data used for executing the program are written. This software program includes a display control program to control displaying on the main touch panel 13, the right-side touch panel 14R, and the left-side touch panel 14L.

In the RAM of the memory device 11, image data of an e-book is stored.

The software program stored in the memory device 11 is appropriately read into the main controller 10, which then executes the software program. The RAM of the memory device 11 is used as a primary storing memory or a working memory.

The main controller 10 is a processor that controls the entire of the mobile terminal 1, and may be a multiprocessor. An example of the main controller 10 is a Central Processing Unit (CPU), a Micro Processing Unit (MPU), a Digital Signal Processor (DSP), an Application Specific Integrated Circuit (ASIC), a Programmable Logic Device (PLD), or a Field Programmable Gate Array (FPGA). Alternatively, the main controller 10 may be a combination containing at least two of a CPU, an MPU, a DSP, an ASIC, a PLD, and an FPGA.

The main controller 10 has a function as a Graphics Processing Unit (GPU) and an HW core.

The main controller 10 executes the display control program and functions as the display switching rate determiner 101 and the display controller 102.

The program (display control program) to achieve the function of the display switching rate determiner 101 and the display controller 102 is provided in the form of being stored in a non-transitory computer-readable recording medium such as a flexible disk, a CD (e.g., CD-ROM, CD-R, and CD-RW), a DVD (e.g., DVD-ROM, DVD-RAM, DVD-R, DVD+R, DVD-RW, DVD+RW, and HD DVD), a Blu-ray disk, a magnetic disk, an optical disk, and a magneto-optical disk. The computer reads the program from the recording medium and forwards the read program to an internal memory device or an external memory device, which stores the program for future use. Alternatively, the program may be stored in, for example, a memory device (recording medium) such as a magnetic disk, an optical disk, and a magneto-optical disk, and be provided from the memory device to the computer through a communication path.

In achieving the function as the display switching rate determiner 101 and the display controller 102, the program stored in the internal memory device (in this embodiment, the RAM or the ROM of the memory device 11) is executed by the microprocessor (in this embodiment, the main controller 10) of the computer. Alternatively, the computer may read the program from a recording medium and then execute the read program.

The display controller 102 controls displaying of an image on the main touch panel 13, the right-side touch panel 14R, and the left-side touch panel 14L.

For example, the display controller 102 causes the main touch panel 13, the right-side touch panel 14R, and the left-side touch panel 14L to display menu screens thereon.

The display controller 102 causes the main touch panel 13 to display an image of an e-book thereon.

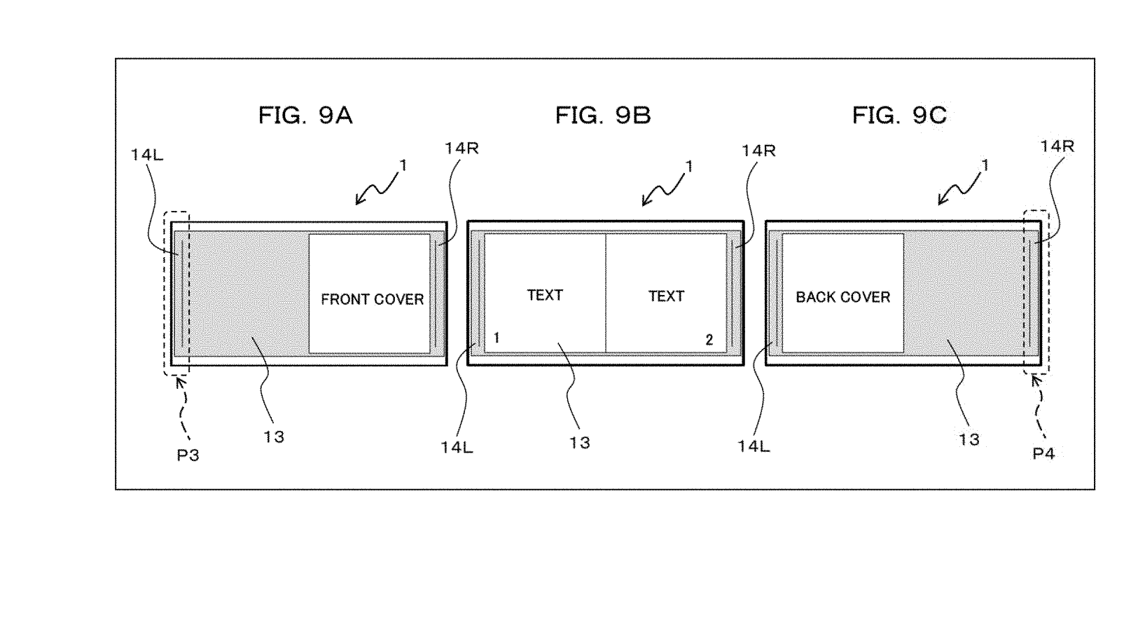

FIGS. 9A-9C are diagrams illustrating examples of displaying an e-book on the main touch panel 13 of the mobile terminal 1 of the first embodiment.

FIGS. 9A-9C illustrate examples of displaying an e-book which is bound on the left end. FIG. 9A illustrates a state where the front cover of the e-book is displayed;

FIG. 9B illustrates a state where a double-page spread of the e-book is displayed; and FIG. 9C illustrates a case where the back cover of the e-book is displayed.

The operation void regions represented by reference numbers P3 and P4 in FIGS. 9A-9C will be described below.

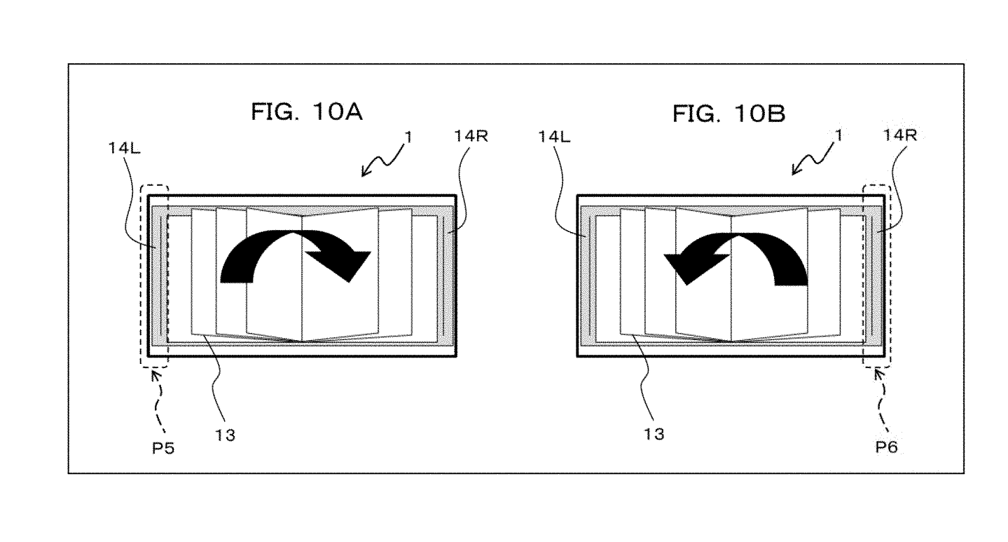

FIGS. 10A and 10B are diagrams illustrating examples of turning pages of an e-book on the main touch panel 13 of the mobile terminal 1 of the first embodiment.

The display controller 102 carries out continuous turning pages that causes the main touch panel 13 to display page images being continuously switched one after another.

FIG. 10A illustrates an example of turning pages of an e-book displayed on the main touch panel 13 from the left to the right. Hereinafter, turning pages of an e-book from the left to the right is referred to as “rightwards turning”.

FIG. 10B illustrates an example of turning pages of an e-book displayed on the main touch panel 13 from the right to the left. Hereinafter, turning pages of an e-book from the right to the left is referred to as “leftwards turning”.

The display controller 102 turns a page of the e-book displayed on the main touch panel 13 in accordance with input operations detected by the main touch panel 13, the right-side touch panel 14R, the left-side touch panel 14L, the right press sensor 15R, the left press sensor 15L, and the acceleration sensor 16.

In the example of FIG. 10A, when the input operations of turning a page via the left-side touch panel 14L, the left press sensor 15L, and the acceleration sensor 16 are detected (see the reference number P5 in FIG. 10A), the display controller 102 displays an e-book in the state of being rightwards turning.

In the example of FIG. 10B, when the input operations of turning a page via the right-side touch panel 14R, the right press sensor 15R, and the acceleration sensor 16 are detected (see the reference number P6 in FIG. 10B), the display controller 102 displays an e-book in the state of being leftwards turning.

When the back-face press on the right press sensor 15R and the left press sensor 15L and thumb isolating or thumb shift on the right-side touch panel 14R and the left-side touch panel 14L are detected, the display controller 102 continuously turns pages of an e-book displayed on the main touch panel 13.

At that time, the display controller 102 switches pages at a turning-page rate calculated by the display switching rate determiner 101 to be detailed below.

Furthermore, when the back-face press and the flapping are detected by the right press sensor 15R and the left press sensor 15L, and the acceleration sensor 16, respectively, the display controller 102 turns a single page of the e-book displayed on the main touch panel 13.

Since no antecedent page is present under a state where the front cover is being displayed on the main touch panel 13, the display controller 102 invalidates an input operation to backwardly turn a page antecedent to the front cover.

For example, under a state of FIG. 9A, the display controller 102 ignores detection of an input via the left-side touch panel 14L and the left press sensor 15L indicated by the reference number P3.

Likewise, since no descendent page is present under a state where the back cover is being displayed on the main touch panel 13, the display controller 102 invalidates an input operation to forwardly turn a page descendent to the back cover.

For example, under a state of FIG. 9C, the display controller 102 ignores detection of an input via the right-side touch panel 14R and the right press sensor 15R indicated by the reference number P4.

The mobile terminal 1 previously sets respective thresholds of the sensors, which threshold are regarded as criteria of a page-turning process such as the start and the end of the page-turning process.

The thresholds are set to be the pressures to be applied to the above sensors S1-S4, which pressures correspond to the pressure applied from the fingers in the following operations for starting and ending turning pages of an actual book. This allows the operator to feel closely like reading an actual book when operating the mobile terminal 1.

(1) Sensor S1:

A threshold s1 is set for a pressure difference between a pressure (first pressure) detected at a position (first position) nearer to the top face of the mobile terminal 1 and a pressure (second pressure) detected at a position (second position) nearer to the back face on portions that the thumbs (articles) of the operator are in contact with and that include each of the right-side touch panel 14R and left-side touch panel 14L disposed on the both side faces of the mobile terminal 1.

If the sensor S1 detects that the pressure (first pressure) detected at the first position is lower than the pressure (second pressure) detected at the second position and also the pressure difference between the first pressure and the second pressure exceeds the threshold s1 or a threshold si_p1, the display controller 102 detects that the operator has isolated the thumb.

Here, the threshold s1 is the threshold to detect an input operation of continuous turning pages while the other threshold si_p1 is the threshold to detect an input operation of turning a single page. The threshold s1_p1 is smaller than the threshold s1.

The operator adjusts the amount of isolating the thumb by adjusting angles (leaving amounts) leaving the tips of the thumbs, touching the right-side touch panel 14R and left-side touch panel 14L, from the right-side touch panel 14R and left-side touch panel 14L.

(2) Sensor S2:

A threshold s2 is set for an amount (displaced amount) of movement of an article being in contact with each of the right-side touch panel 14R and the left-side touch panel 14L from a position nearer to the top face to the position nearer to the back face.

If the sensor S2 detects that the amount of movement of an article being in contact with each the right-side touch panel 14R and the left-side touch panel 14L from a position nearer to the top face to the position nearer to the back face exceeds the threshold s2, the display controller 102 detects that the operator has shifted the thumbs.

The operator adjusts the amount of shifting the thumbs by adjusting amounts (displaced amounts) of moving the thumbs touching on the right-side touch panel 14R and the left-side touch panel 14L from a position nearer to the top face to the position nearer to the back face.

(3) Sensor S3:

A threshold s3 is set for the pressure applied to each of the right press sensor 15R and the left press sensor 15L disposed back face of the mobile terminal 1.

When the sensor S3 detects that a pressure applied to each of the right press sensor 15R and the left press sensor 15L exceeds the threshold s3, the display controller 102 detects that the operator has pressed the back face of the mobile terminal 1.

The operator adjusts the amount of back-face press by adjusting the forces (pressing forces) applied to the right press sensor 15R and the left press sensor 15L.

(4) Sensor S4:

A threshold s4 is set for an acceleration of the acceleration sensor 16.

When the acceleration sensor 16 detects that the acceleration in the direction towards the top face of the mobile terminal 1 exceeds the threshold s4, the display controller 102 detects that the operator has flapped the mobile terminal 1.

The operator successfully flapping the mobile terminal 1 by adjusting the rate of flapping the acceleration sensor 16 (mobile terminal 1).

The above thresholds s1-s4 may be determined in advance and stored in a predetermined memory region in the memory device 11. Alternatively, the operator may arbitrarily determine part of the thresholds s1-s4. The mobile terminal 1 may further include a user interface that allows arbitrarily setting of the thresholds s1-s4.

In reading actual books, force applied to turn a page may be different with the thickness of paper and the size of the book. Considering the above, some combinations of the thresholds s1-s4 according to the type of paper and/or another factor may be prepared beforehand and one from the combinations may be selected on the basis of the type of paper.

(5) Continuous Turning Pages:

When no input operation is made from the right-side touch panel 14R, the left-side touch panel 14L, the right press sensor 15R, and the left press sensor 15L, the display controller 102 turns no page because it is estimated that the operator does not touch these sensors and does not make any page-turning operation.

When an input operation is made on either one of a group of the right-side touch panel 14R and the left-side touch panel 14L and a group of the right press sensor 15R and the left press sensor 15L, the display controller 102 turns no page because it is estimated that the operator is touching either one of the group of sensors.

(5-1) Isolating Thumb:

When both following conditions (i) and (ii) are satisfied, the display controller 102 determines that the operator has isolated the thumb, touching at least one of the right-side touch panel 14R and the left-side touch panel 14L and also at least one of the right press sensor 15R and the left press sensor 15L, and therefore starts the continuous turning pages of the e-book.

(i) The pressure applied to the right press sensor 15R or the left press sensor 15L (sensor S3) is larger than the threshold s3.

(ii) On the right-side touch panel 14R or the left-side touch panel 14L (sensor S1), a pressure applied to the position nearer to the top face (tip of the thumb) is smaller than a pressure applied to the position nearer to the back face (base of the thumb) and the pressure difference between these pressures is larger than the threshold s1.

(5-2) Thumb Shifting:

When both following conditions (iii) and (iv) are satisfied, the display controller 102 determines that the operator has shifted the thumb, touching at least one of the right-side touch panel 14R and the left-side touch panel 14L and also at least one of the right press sensor 15R and the left press sensor 15L, and starts the continuous turning pages of the e-book.

(iii) The pressure applied to the right press sensor 15R or the left press sensor 15L (sensor S3) is larger than the threshold s3.

On the right-side touch panel 14R or the left-side touch panel 14L, an amount (displaced amount) of moving an article (i.e., the thumb of the operator) from the position nearer to the top face (tip of the thumb) to the position nearer to the back face (base of the thumb), keeping in contact with the touch panel is larger than the threshold s2.

While pages are being turned, the display controller 102 ignores an input operation to turn a page made on the opposite side from the side satisfying conditions (i) and (ii) or conditions (iii) and (iv). For example, while an input operation to turn a page is made via the left-side touch panel 14L and left press sensor 15L, the display controller 102 ignores an input operation to turn a page made via the right-side touch panel 14R and the right press sensor 15R.

If, at both of the right-side and left-side of the mobile terminal, the conditions (i) and (ii) or the conditions (iii) and (iv) are satisfied, the display controller 102 calculates the sum of pressures applied to the sensor S1 and the sensor S3 and carries out a process in response to an input operation to turn a page on the side having a larger sum of pressure. This means that the display controller 102 ignores the input operation to turn a page from the side having a smaller sum of pressure.

(6) Turning a Single Page:

If the right-side touch panel 14R, the left-side touch panel 14L, the right press sensor 15R, and the left press sensor 15L all do not make an input in turning a single page, the display controller 102 does not turn a page because it is estimated that the operator does not touch these sensors and does not make an operation to turn a page.

(6-1) Flapping

If the following conditions (v)-(vii) are all satisfied, the display controller 102 determines that the operator flaps the mobile terminal 1 by touching at least one of the right-side touch panel 14R and the left-side touch panel 14L and at least one of the right press sensor 15R and the left press sensor 15L, and then starts turning a single page of the e-book.

(v) The pressure applied to the right press sensor 15R or the left press sensor 15L (sensor S3) is larger than the threshold s3.

(vi) On the right-side touch panel 14R or the left-side touch panel 14L (sensor S1), a pressure applied to a position nearer to the top face (i.e., closer to the tip of the thumb) is smaller than a pressure applied to a position nearer to the back side of the thumb (base of the thumb) and also the difference between these pressures is larger than the threshold s1_p1 and smaller than the threshold s1 (this means that the condition for continuous turning page is not satisfied).

(vii) The acceleration applied to the acceleration sensor 16 (sensor S4) in the direction towards the top face of the mobile terminal 1 is larger than the threshold s4.

In relation to the direction of turning pages, a page on the side, to which a larger acceleration is applied among the left and right sides of the mobile terminal 1, is turned to the opposite side.

When the display controller 102 continuously turns pages of an e-book, the display switching rate determiner 101 determines the rate of switching pages on the e-book displayed on the main touch panel 13.

In turning pages by finger isolating, the display switching rate determiner 101 increases the rate of turning pages with increasing of a pressing pressure applied to the right press sensor 15R and the left press sensor 15L (sensor S3) and decreases the rate of turning pages with decreasing of the pressing pressure.

In turning pages, the display switching rate determiner 101 increases the rate of turning pages with increasing of the pressure difference between a position nearer to the top face and a position nearer to the back face detected by the right-side touch panel 14R or the left-side touch panel 14L (sensor S1), and decreases the rate of turning pages with decreasing of the pressure difference.

If the pressure difference between a position nearer to the top face and a position nearer to the back face on the right-side touch panel 14R or the left-side touch panel 14L (sensor S1) is large, it is considered that the degree of isolating the tip of the thumb from the sensor by the operator is large. In contrast, if the pressure difference is small, it is considered that the degree of isolating the tip of the thumb is small.

If at least one of the above conditions (i) and (iii) comes not to be satisfied, the display switching rate determiner 101 stops turning pages. In other words, the display switching rate determiner 101 sets the rate of turning pages to zero.

Meanwhile, in turning pages through thumb shifting, the display switching rate determiner 101 increases a rate of turning pages with increasing of the press pressure applied to the right press sensor 15R or the left press sensor 15L (sensor S3), and decreases the rate of turning pages with decreasing of the press pressure.

In turning pages, the display switching rate determiner 101 increases a rate of turning pages with increasing of an amount of displacement of finger from a position nearer to the top face to a position nearer to the back face and decreases the rate of turning pages with decreasing of an amount of displacement of finger.

If at least one of the above conditions (iii) and (iv) comes not to be satisfied, the display switching rate determiner 101 stops turning pages. In other words, the display switching rate determiner 101 sets the rate of turning pages to zero.

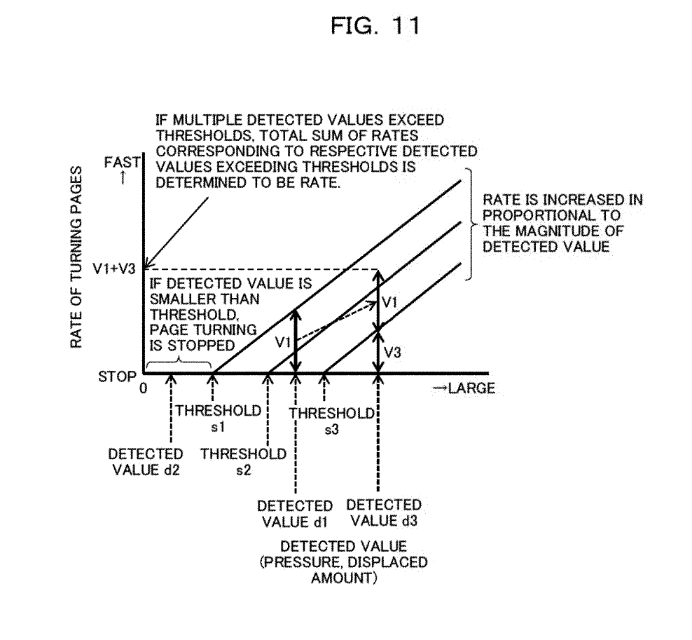

FIG. 11 is a diagram illustrating an example of a method of calculating a rate of turning pages by the display switching rate determiner 101 of the mobile terminal 1 of the first embodiment.

In FIG. 11, the detected value d1 represents a value detected by the sensor S1, that is, a pressure difference between a position nearer to the top face and a position nearer to the back face on the right-side touch panel 14R and left-side touch panel 14L.

The detected value d2 represents a value detected by the sensor S2, that is, an amount of displacement of the thumb of the operator from a position nearer to the top face to a position nearer to the back face on the right-side touch panel 14R and left-side touch panel 14L.

The detected value d3 represents a value detected by the sensor S3, that is, a pressure applied to the right press sensor 15R or the left press sensor 15L.

If a detected value is equal to or smaller than the threshold, turning of pages is stopped, which means the rate of turning pages is zero. In the example of FIG. 11, the detected value d2 is smaller than the threshold s2. In this case, the rate of turning page is set to be zero and therefore turning of pages is stopped.

On the other hand, if a detected value exceeds the threshold, the display switching rate determiner 101 increases the rate of turning pages with increasing of the detected value. In other words, the display switching rate determiner 101 increases the rate of turning pages with increase of a degree of the detected value exceeding the threshold.

If multiple detected values exceed the threshold, the display switching rate determiner 101 adds the respective rates corresponding to the detected values exceeding the threshold to one another in order to obtain the rate of turning pages.

In the example of FIG. 11, the detected values d1 and d3 exceed the thresholds s1 and s3, respectively. In this case, the display switching rate determiner 101 determines the rate of turning pages to be the sum “v1+v3” of the rate v1 corresponding to the detected value d1 and the rate v3 corresponding to the detected value d3 to be the rate of turning pages.

Accordingly, the display switching rate determiner 101 functions as a determiner that determines a rate (i.e., rate of turning pages) of switching the page images to be displayed using an amount of input operation via the right-side touch panel 14R and the left-side touch panel 14L and an amount of input operation via the right press sensor 15R and the left press sensor 15L.

(B) Operation:

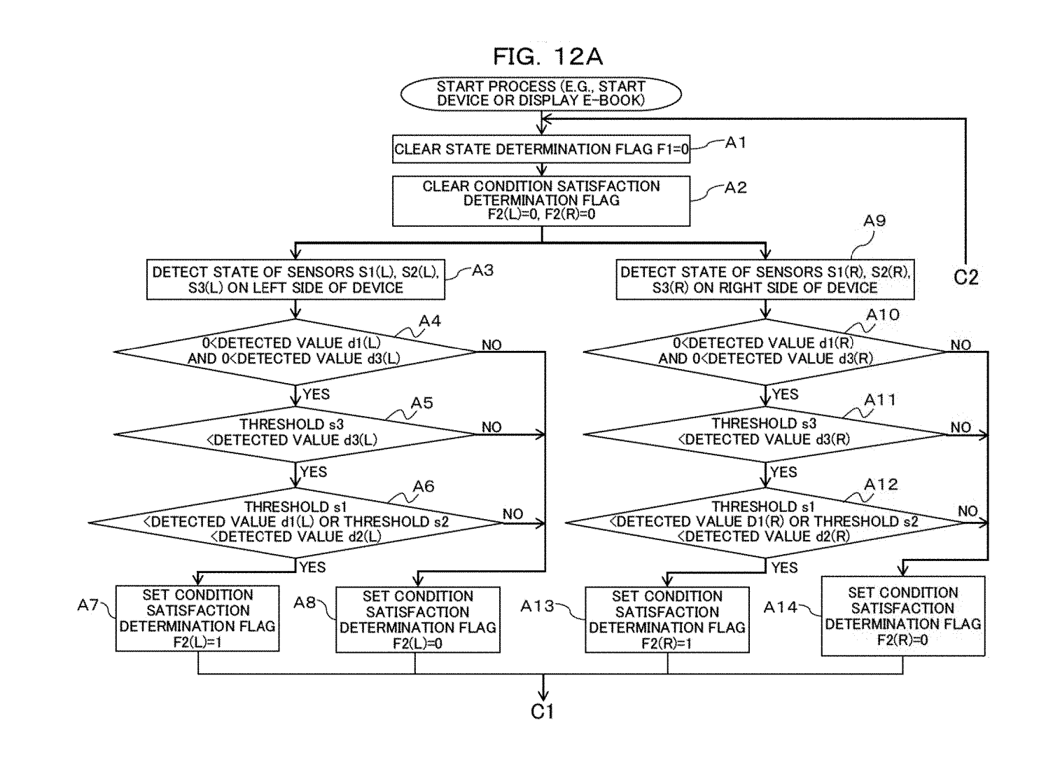

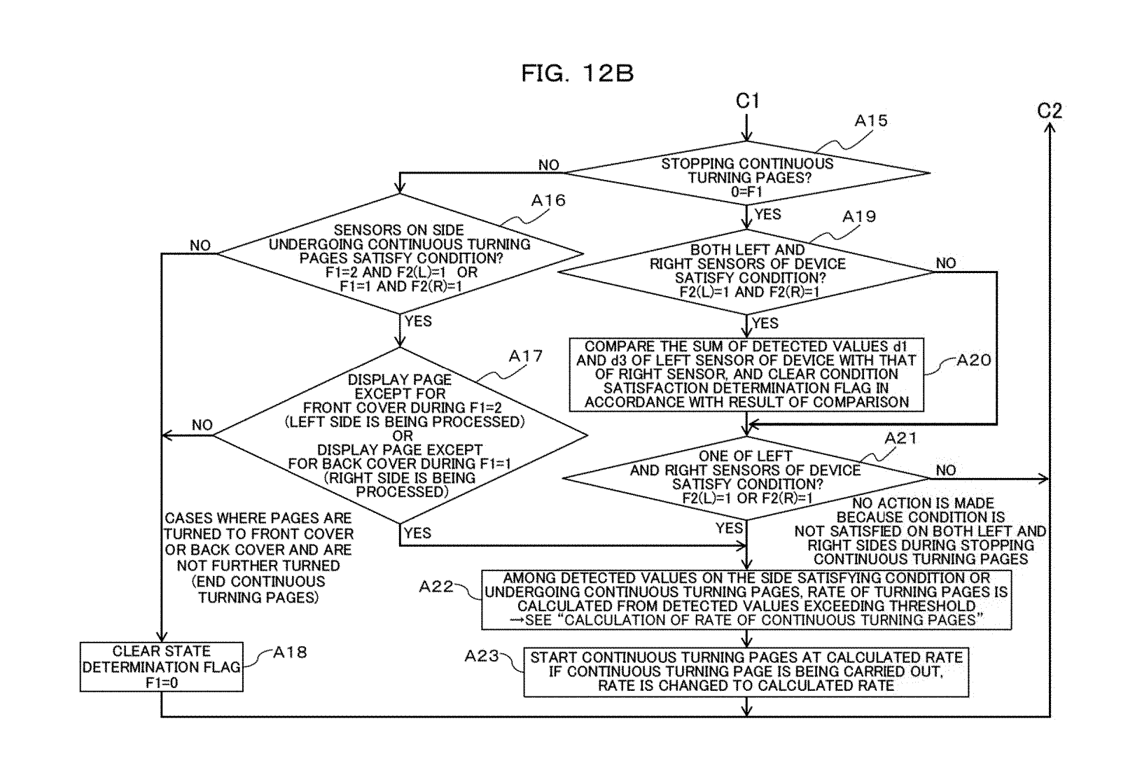

Description will now be made in relation to a process carried out when the mobile terminal 1 of the first embodiment is continuously turning pages with reference to the flow diagrams of FIGS. 12A and 12B (steps A1-A23). FIG. 12A denotes steps A1-A14 and FIG. 12B denotes steps A15-A23.

In the following process, the display controller 102 uses a state determination flag F1 for continuous turning pages and a condition satisfaction determination flag F2 for continuous turning page. Hereinafter, the state determination flag F1 for continuous turning page and the condition satisfaction determination flag F2 for continuous turning pages are sometimes referred to as a state determination flag F1 and a condition satisfaction determination flag F2, respectively.

Here, the state determination flag F1 for continuous turning pages being set to the value “2” (F1=2) represents that pages are being turned in response to operating of the left-side touch panel 14L and the left press sensor 15L disposed on the left side of the mobile terminal 1.

Hereinafter, the left-side touch panel 14L (sensor S1 and Sensor S2) and the left press sensor 15L (sensor S3) are referred to as sensors on the left side of the device and are represented by reference numbers S1(L), S2(L), and S3(L), respectively. In addition, values (detected values) detected by these sensors S1(L), S2(L), and S3(L) may sometimes be represented by reference numbers d1(L), d2(L), and d3(L), respectively.

The state determination flag F1 being set to the value “1” (F1=1) represents that pages are being turned in response to operating of the right-side touch panel 14R and the right press sensor 15R disposed on the right side of the mobile terminal 1. Hereinafter, the right-side touch panel 14R (sensor S1 and Sensor S2) and the right press sensor 15R (sensor S3) are referred to as sensors on the right side of the device and are represented by reference numbers S1(R), S2(R), and S3(R), respectively. In addition, values (detected values) detected by these sensors S1(R), S2(R), and S3(R) may sometimes be represented by reference numbers d1(R), d2(R), and d3(R), respectively.

The state determination flag F1 being set to the value “0” (F1=0) represents that continuous turning page is stopped.

The condition satisfaction determination flag F2 for continuous turning pages includes two flags of a flag F2(L) for the sensor on the left side of the device and a flag F2(R) for the sensor on the right side of the device.

These flags F2(L) and F2(R) being set to be the value “1” (i.e., F2(L)=1 and F2(R)=1) represents that the condition to carryout continuous turning pages is satisfied. In contrast, the flags F2(L) and F2(R) being set to be the value “0” (i.e., F2(L)=0 and F2(R)=0) represents that the condition to carry out continuous turning page is not satisfied.

Hereinafter, the condition satisfaction determination flags F2(L) and F2(R) for continuous turning pages are sometimes referred to as condition satisfaction determination flags F2(L) and F2(R).

For example, activation of the mobile terminal 1 or the input of an instruction to display an e-book by the operator causes the main touch panel 13 to display the e-book thereon.

In step A1 of FIG. 12A, the display controller 102 clears the state determination flag F1 (F1=0).

In step A2 of FIG. 12A, the display controller 102 clears the condition satisfaction determination flags F2(L) and F2(R) (F2(L)=0 and F2(R)=0).

In step A3 of FIG. 12A, the display controller 102 detects the states of the sensors S1(L), S2(L), and S3(L) on the left side of the device.

In step A4 of FIG. 12A, the display controller 102 confirms whether the detected value d1(L) by the sensor S1(L) is larger than zero and also whether the detected value d3(L) by the sensor S3(L) is larger than zero.

If the detected value d1(L) is larger than zero and also the detected value d3(L) is larger than zero as the result of the confirmation in step A4 (see YES route in step A4), the process moves to step A5 of FIG. 12A.

In step A5, the display controller 102 confirms whether the detected value d3(L) by the sensor S3(L) is larger than the threshold s3. If the detected value d3(L) is larger than the threshold s3 as a result of the confirmation (see YES route in step A5), the process moves to step A6 of FIG. 12A.

In step A6, the display controller 102 confirms whether at least one of the conditions that the detected value d1(L) by the sensor S1(L) is larger than the threshold s1 and that the detected value d2(L) by the sensor S2(L) is larger than the threshold s2 is satisfied.

If the detected value d1(L) is larger than the threshold s1 or the detected value d2(L) is larger than the threshold s2 as a result of the confirmation (see YES route in step A6), the process moves to step A7 of FIG. 12A.

In step A7, the condition satisfaction determination flag F2(L) is set to one (F2(L)=1). Then the process moves to step A15 of FIG. 12B.

On the other hand, if the condition that the detected value d1(L) is larger than zero and also the detected value d3(L) is larger than zero is not satisfied as a result of the confirmation of step A4 (see NO route in step A4), the process moves to step A8 of FIG. 12A.

Also if the detected value d3(L) is equal to or less than the threshold s3 as a result of the confirmation of step A5 (see NO route in step A5), the process moves to step A8.

Further, if neither the condition that the detected value d1(L) is larger than the threshold s1 nor the condition that the detected value d2(L) is larger than the threshold s2 is satisfied as a result of the confirmation of step A6 (see NO route in step A6), the process moves to step A8.

In step A8, the condition satisfaction determination flag F2(L) is set to zero (F2(L)=0). Then the procedure moves to step A15 of FIG. 12B.

In parallel with step A3, the display controller 102 detects the states of the sensors S1(R), S2(R), and S3(R) on the right side of the device in step A9 of FIG. 12A.

In step A10 of FIG. 12A, the display controller 102 confirms whether the detected value d1(R) by the sensor S1(R) is larger than zero and also whether the detected value d3(R) by the sensor S3(R) is larger than zero.

If the detected value d1(R) is larger than zero and also the detected value d3(R) is larger than zero as the result of the confirmation in step A10 (see YES route in step A10), the process moves to step A11 of FIG. 12A.

In step A11, the display controller 102 confirms whether the detected value d3(R) by the sensor S3(R) is larger than the threshold s3. If the detected value d3(R) is larger than the threshold s3 as a result of the confirmation (see YES route in step A11), the process moves to step A12 of FIG. 12A.

In step A12, the display controller 102 confirms whether at least one of the conditions of the detected value d1(R) by the sensor S1(R) being larger than the threshold s1 and the detected value d2(R) by the sensor S2(R) being larger than the threshold s2 is satisfied.

If the detected value d1(R) is larger than the threshold s1 or the detected value d2(R) is larger than the threshold s2 as a result of the confirmation (see YES route in step A12), the process moves to step A13 of FIG. 12A.

In step A13, the condition satisfaction determination flag F2(R) is set to one (F2(R)=1). Then the process moves to step A15 of FIG. 12B.

On the other hand, if the condition that the detected value d1(R) is larger than zero and also the detected value d3(R) is larger than zero is not satisfied as a result of the confirmation of step A10 (see NO route in step A10), the process moves to step A14 of FIG. 12A.

Also if the detected value d3(R) is equal to or less than the threshold s3 as a result of the confirmation of step A11 (see NO route in step A11), the process moves to step A14.

Further, if neither the condition that the detected value d1(R) is larger than the threshold s1 nor the condition that the detected value d2(R) is larger than the threshold s2 is satisfied as a result of the confirmation of step A12 (see NO route in step A12), the process moves to step A14.

In step A14, the condition satisfaction determination flag F2(R) is set to zero (F2(R)=0). Then the process moves to step A15 of FIG. 12B.

In step A15, the display controller 102 confirms whether the continuous turning pages is being stopped. Specifically, the display controller 102 confirms whether the state determination flag F1 is set to zero (F1=0).

As a result of confirmation, if the continuous turning pages is not being stopped (see NO route in step A15), which means that continuous turning pages is being carried out, the process moves to step A16 of FIG. 12B.

In step A16, the display controller 102 confirms whether the sensor condition is satisfied on the side undergoing continuous turning pages. Namely, the display controller 102 confirms whether at least one of a condition that the state determination flag F1=2 and the condition satisfaction determination flag F2(L)=1 and the condition that the state determination flag F1=1 and the condition satisfaction determination flag F2(R)=1 is satisfied.

If the sensor condition is not satisfied on the side undergoing continuous turning pages as a result of the confirmation (see NO route in step A16), the process moves to step A18 of FIG. 12B. In step A18, the state determination flag F1 is cleared (F1=0). After that, the process returns to step A1 of FIG. 12A.

If the sensor condition is satisfied on the side undergoing continuous turning pages as a result of the confirmation of step A16 (see YES route in step A16), the process moves to step A17 of FIG. 12B.

In step A17, the display controller 102 confirms whether either one of the following conditions (a) and (b) is satisfied.

(a) The state determination flag F1=2, which means that pages are being turned in response to the operation of the sensors on the left side of the device, and the main touch panel 13 is in a displaying state except for the state (see FIG. 9A) in which only the front cover of an e-book bound on the left end is displayed.

(b) The state determination flag F1=1, which means that pages are being turned in response to the operation of the sensors on the right side of the device, and the main touch panel 13 is in a display state except for the state (see FIG. 9C) in which only the back cover of an e-book bound on the right end is displayed.

If neither the condition (a) nor the condition (b) is satisfied as a result of the confirmation of step A17 (NO route in step A17), the process moves to step A18.

If either the condition (a) or the condition (b) is satisfied as a result of the confirmation of step A17 (YES route in step A17), the process moves to step A22.

As a result of confirmation, if the continuous turning pages is not stopped (see YES route in step A15), the procedure moves to step A19 of FIG. 12B.

In step A19, the display controller 102 confirms whether the sensors on the left side of the device and the sensors on the right side of the device both satisfy the condition for continuous turning pages. In other words, the display controller 102 confirms whether both condition satisfaction determination flag F2(L)=1 and the condition satisfaction determination flag F2(R)=1 are satisfied.

As a result of the confirmation, both the sensors on the left and right sides do not satisfy the condition for continuous turning pages (see NO route in step A19), the process skips step A20 of FIG. 12B and moves to step A21 of FIG. 12B.

In contrast, if both the sensors on the left and right sides satisfy the condition for continuous turning pages as a result of the confirmation in step A19 (see YES route in step A19), the process moves to step A20 of FIG. 12B.

In step A20, the display controller 102 compares the sum of the detected values d1(L) and d3(L) detected by the sensors S1(L) and S3(L) on the left side of the device with the sum of the detected values d1(R) and d3(R) detected by the sensors S1(R) and S3(R) on the right side of the device. The display controller 102 clears the condition satisfaction determination flag F2 in accordance with the result of the comparison.

Specifically, if the sum of the detected values d1(L) and d3(L) detected by the sensors S1(L) and S3(L) is larger than the sum of the detected values d1(R) and d3(R) detected by the sensors S1(R) and S3(R), the display controller 102 clears the condition satisfaction determination flag F2(R) of the sensors on the right side of the device.

d1(L)+d3(L)>d1(R)+d3(R)→F2(R)=0

In contrast, if the sum of the detected values d1(L) and d3(L) detected by the sensors S1(L) and S3(L) is smaller than the sum of the detected values d1(R) and d3(R) detected by the sensors S1(R) and S3(R), the display controller 102 clears the condition satisfaction determination flag F2(L) of the sensors on the left side of the device.

d1(L)+d3(L)<d1(R)+d3(R)→F2(L)=0

If the sensors on the both left and right sides of the device satisfy the condition of continuous turning pages, the display controller 102 assumes that the side having a smaller sum of the detected values does not satisfy the condition of continuous turning pages. Consequently, pages are continuously turned on the side having a larger sum of the detected values.

If the sum of the detected values d1(L) and d3(L) detected by the sensors S1(L) and S3(L) on the left side of the device is the same as the sum of the detected values d1(R) and d3(R) detected by the sensors S1(R) and S3(R) on the right side of the device, the display controller 102 assumes that the both sides do not satisfy the condition of continuous turning pages.

After that, in step A21 of FIG. 12B, the display controller 102 confirms whether either the sensors on the left side of the device or the sensors on the right side of the device satisfy the condition of continuous turning pages.

In other words, the display controller 102 confirms whether either the condition satisfaction determination flag F2(L)=1 or the condition satisfaction determination flag F2(R)=1 is satisfied.

If either one of the sensors on the left side of the device and the sensors on the right side of the device does not satisfy the condition of continuous turning pages (see NO route in step A21), the process returns to step A1 of FIG. 12A. While continuous turning pages is stopped and also the both sides do not satisfy the condition of continuous turning pages, pages are not turned.

If either the sensors on the left side of the device or the sensors on the right side of the device satisfies the condition of continuous turning pages (see YES route in step A21), the process moves to step A22 in FIG. 12B.

In step A22, the display switching rate determiner 101 calculates the rate of turning pages from detected values exceeding a threshold among the detected values on the side satisfying the condition of continuous turning pages or carrying out continuous turning pages.

After that, in step A23 of FIG. 12B, the display controller 102 carries out continuous turning pages at the rate determined by the display switching rate determiner 101. In other words, the display controller 102 successively switches pages of the e-book being displayed on the main touch panel 13 at the determined rate of turning pages. Then, the process returns to step A1 of FIG. 12A.

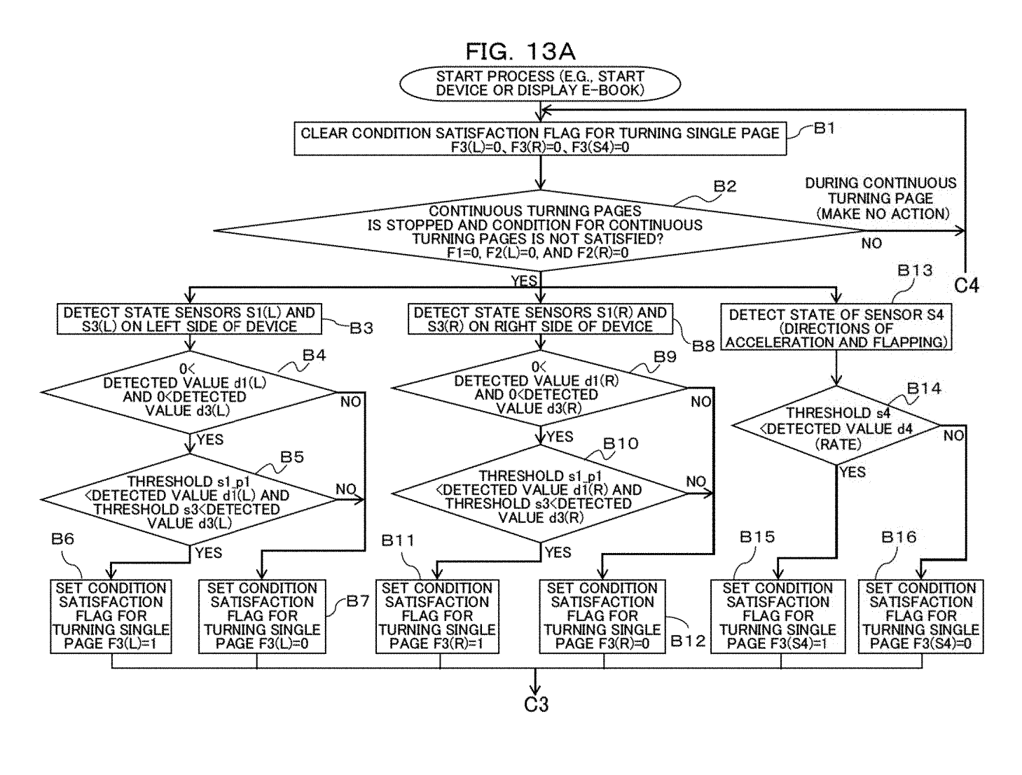

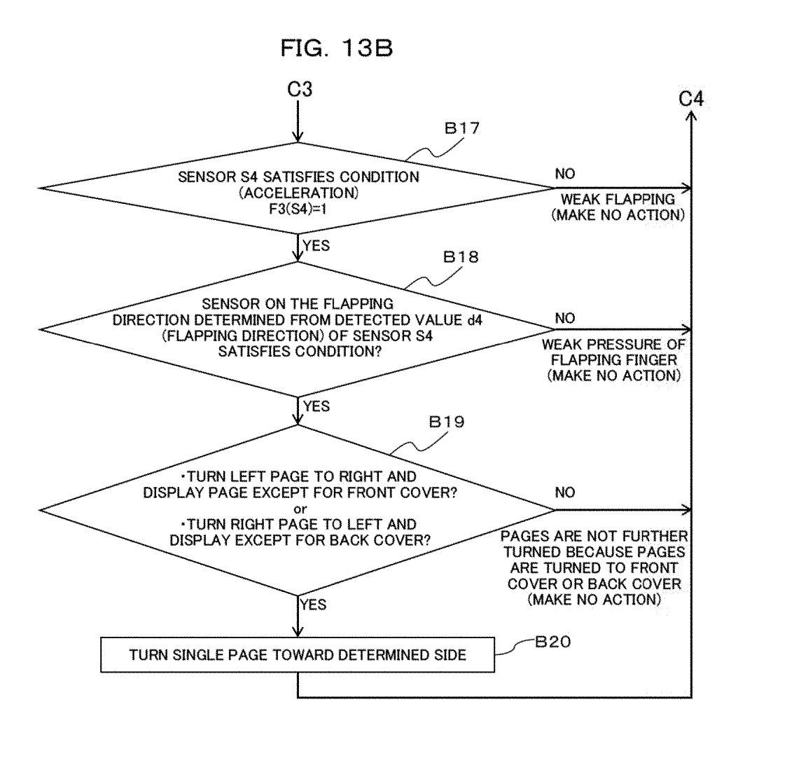

Description will now be made in relation to a process performed when turning of a single page is carried out in the mobile terminal 1 with reference to the flow diagrams of FIGS. 13A and 13B (steps B1-B20). FIG. 13A denotes the process of steps B1-B16 and FIG. 13B denotes the process of steps B17-B20.

The following process uses a condition satisfaction determination flag F3 for turning a single page in addition to the state determination flag F1 for continuous turning pages and the condition satisfaction determination flags F2(L) and F2(R) for continuous page turning that are detailed above.

The condition satisfaction determination flag F3 for turning a single page includes a flag F3(L) for the sensors on left side of the device, a flag F3(R) for the sensors on the right side of the device, and a flag F3(S4) for the acceleration sensor 16 (sensor S4).

The flags F3(L), F3(R), and F3(S4) all being set to a value “1” (i.e., F2(L)=1, F2(R)=1, F3(S4)=1) represent that the condition for turning a single page is satisfied. In contrast, the flags F3(L), F3(R), and F3(S4) all being set to a value “0” (i.e., F2(L)=0, F2(R)=0, F3(S4)=0) represent that the condition for turning a single page is not satisfied.

Hereinafter, the condition satisfaction determination flags F3(L), F3(R), and F3(S4) for turning a single page are sometimes referred to as the condition satisfaction determination flags F3(L), F3(R), and F3(S4).

Activation of the mobile terminal 1 or the input of an instruction to display an e-book by the operator causes the main touch panel 13 to display the e-book thereon.

In step B1 of FIG. 13A, the display controller 102 clears the condition satisfaction determination flags F3(L), F3(R), and F3(S4) (i.e., F3(L)=0, F3(R)=0, and F3(S4)=0).

In step B2 of FIG. 13A, the display controller 102 confirms whether continuous turning pages is stopped and also the condition for continuous turning pages is not satisfied. Specifically, the display controller 102 confirms whether the condition that the state determination flag F1=0 and the condition satisfaction determination flags F2(L)=0 and F2(R)=0 are satisfied.

As a result of confirmation, if the continuous turning pages is being carried out or the condition for continuous turning pages is satisfied (see NO route in step B2), the process makes no action and returns to step B1.

In contrast, if continuous turning pages is stopped and also the condition for continuous turning pages is not satisfied as a result of the confirmation of step B2 (see YES route in step B2), the process moves to steps B3, B8, and B13 of FIG. 13A. These steps B3, B8, and B13 may be carried out in parallel or in an appropriate order.

In step B3, the display controller 102 detects the states of sensors S1(L) and S3(L) on the left side of the device.

In step B4 of FIG. 13A, the display controller 102 confirms whether the detected value d1(L) by the sensor S1(L) is larger than zero and also the detected value d3(L) by the sensor S3(L) is larger than zero.

If the detected value d1(L) is larger than zero and also the detected value d3(L) is larger than zero as a result of the confirmation in step B4 (see YES route in step B4), the process moves to step B5 of FIG. 13A.

In step B5, the display controller 102 confirms whether at least one of a condition that the detected value d1(L) by the sensor S1(L) is larger than the threshold s1_p1 and a condition that the detected value d3(L) by the sensor S3(L) is larger than the threshold s3 is satisfied.

As a result of the confirmation, if the detected value d1(L) is larger than the threshold s1_p1 and also the detected value d3(L) by the sensor S3(L) is larger than the threshold s3 (see YES route in step B5), the process moves to step B6 of FIG. 13A.

In step B6, the condition satisfaction determination flag F3(L) is set to one (F3(L)=1). After that, the process moves to step B17 of FIG. 13B.

On the other hand, if the condition that the detected value d1(L) is larger than zero and also the detected value d3(L) is larger than zero is not satisfied as a result of the confirmation in step B4 (see NO route in step B4), the process moves to step B7 of FIG. 13A.

Furthermore, if the condition that the detected value d1(L) is larger than the threshold s1_p1 and also the detected value d3(L) is larger than the threshold s3 is not satisfied as a result of the confirmation of step B5 (see NO route in step B5), the process moves to step B7.

In step B7, the condition satisfaction determination flag F3(L) is set to zero (F3(L)=0). After that, the process moves to step B17 of FIG. 13B.

In parallel with step B3, the display controller 102 detects the states of the sensors S1(R) and S3(R) on the right side of the device in step B8 of FIG. 13A.

In step B9 of FIG. 13A, the display controller 102 confirms whether the detected value d1(R) by the sensor S1(R) is larger than zero and also the detected value d3(R) by the sensor S3(R) is larger than zero.

If the detected value d1(R) is larger than zero and also the detected value d3(R) is larger than zero as a result of the confirmation in step B9 (see YES route in step B9), the process moves to step B10 of FIG. 13A.

In step B10, the display controller 102 confirms whether at least one of a condition that the detected value d1(R) by the sensor S1(R) is larger than the threshold s1_p1 and a condition that the detected value d3(R) by the sensor S3(R) is larger than the threshold s3 is satisfied.

As a result of the confirmation, if the detected value d1(R) is larger than the threshold s1_p1 and also the detected value d3(R) is larger than the threshold s3 (see YES route in step B10), the process moves to step B11 of FIG. 13A.

In step B11, the condition satisfaction determination flag F3(R) is set to one (F3(R)=1). After that, the process moves to step B17 of FIG. 13B.

On the other hand, if the condition that the detected value d1(R) is larger than zero and also the detected value d3(R) is larger than zero is not satisfied as a result of the confirmation in step B9 (see NO route in step B9), the process moves to step B12 of FIG. 13A.

Furthermore, if the condition that the detected value d1(R) is larger than the threshold s1_p1 and also the detected value d3(R) is larger than the threshold s3 is not satisfied as a result of the confirmation of step B10 (see NO route in step B10), the process moves to step B12.

In step B12, the condition satisfaction determination flag F3(R) is set to zero (F3(R)=0). After that, the process moves to step B17 of FIG. 13B.

In parallel with steps B3 and B8, the display controller 102 detects the state of the sensor S4 (acceleration sensor 16) in step B13 of FIG. 13A. Specifically, the display controller 102 detects the rate of the acceleration sensor 16 and the direction of flapping. Here, the result of detecting the rate by the acceleration sensor 16 is referred to as the detected value d4 (rate) and the result of detecting the direction of flapping by the acceleration sensor 16 is referred to as the detected value d4 (flapping direction).

In step B14 of FIG. 13A, the display controller 102 confirms whether the detected value d4 (rate) by the sensor S4 is larger than a threshold s4.

If the detected value d4 (rate) is larger than a threshold s4 as a result of the confirmation (see YES route in step B14), the process moves to step B15 of FIG. 13A.

In step B15, the condition satisfaction determination flag F3(S4) is set to one (F3(S4)=1). After that, the process moves to step B17 of FIG. 13B.

On the other hand, as a result of the confirmation in step B14, if the detected value d4 (rate) is equal to or smaller than the threshold s4 (see NO route in step B14), the process moves to step B16 of FIG. 13A.

In step B16, the condition satisfaction determination flag F3 (S4) is set to zero (F3(S4)=0). Then, the process moves to step B17 of FIG. 13B.

In step B17, the display controller 102 confirms whether the sensor S4 (acceleration sensor 16) satisfies the condition for turning a single page.

Specifically, the display controller 102 confirms whether the condition satisfaction determination flag F3(S4)=1 is satisfied.

As a result of the confirmation, if the condition for turning a single page is not satisfied (see NO route in step B17), flapping is determined to be weak and the process returns to step B1 of FIG. 13A without making any action.

In contrast, if the condition for turning a single page is satisfied as a result of the confirmation of step B17 (see YES route in step B17), the process moves to step B18 of FIG. 13B.

In step B18, the display controller 102 confirms whether the sensors S1 and S3 in the direction of flapping determined by the detected value d4 (flapping direction) by the sensor S4 satisfy the condition for turning a single page, and on the basis of the result of the confirmation, determines the direction of turning a page.

For example, in flapping from the left side of the device towards the front right direction, the display controller 102 confirms whether the condition satisfaction determination flag F3(L)=1 is satisfied. If F3(L)=1 is satisfied, the direction of turning a page is “turn the left page to right”.

In flapping from the right side of the device towards the front left direction, the display controller 102 confirms whether the condition satisfaction determination flag F3(R)=1 is satisfied. If F3(R)=1 is satisfied, the direction of turning a page is “turn the right page to left”.

If the sensors S1 and S3 in the direction of flapping do not satisfy the condition for turning a single page in step B18 (see NO route in step B18), the pressure difference and the pressure applied from the flapping fingers are determined to be weak and the process returns to step B1 of FIG. 13A without making any action.

In contrast, if the sensors S1 and S3 in the direction of flapping satisfy the condition for turning a single page in step B18 (see YES route in step B18), the process moves to step B19.

In step B19, the display controller 102 confirms whether at least one of the following conditions (a) and (b) is satisfied.

(a) the direction of turning a page is “turn the left page to right” and the main touch panel 13 is in a displaying state except for displaying only the front cover of an e-book bound on the left end (see FIG. 9A).

(b) the direction of turning a page is “turn the right page to left” and the main touch panel 13 is in a displaying state except for displaying only the back cover of an e-book bound on the left end (see FIG. 9C).

As a result of confirmation of step B19, if neither the conditions (a) nor (b) is satisfied (NO route in step B19), the pages are turned up to the front cover or to the back cover and are not turned any further. The process returns to step B1 without making any action.

On the other hand, if at least one of the conditions (a) and (b) is satisfied (see YES route in step B19), the process moves to step B20 of FIG. 13B.

In step B20, the display controller 102 turns a single page in the determined direction and then returns the process to step B1 of FIG. 13A.

(C) Effects:

As detailed above, the mobile terminal 1 of the first embodiment includes the right-side touch panel 14R and the left-side touch panel 14L, which are associated with the fore edges of a book.

With this configuration, the operator continuously turns pages of an e-book by isolating or shifting the thumb touching the right-side touch panel 14R or the left-side touch panel 14L, feeling as if reading an actual paper book.

Accordingly, the operator, even if not accustomed to operating the mobile terminal 1, can sensuously turn the pages of an e-book.

In turning pages of the e-book, the mobile terminal 1 detects a pressure difference between a pressure at a position closer to the top face and a pressure at a position closer to the back face on the right-side touch panel 14R or the left-side touch panel 14L, and increases the rate of turning pages with increasing a value of the detected value exceeding the threshold. This also makes the operator possible to continuously turn pages of an e-book, feeling as if reading an actual paper book.

Besides, the mobile terminal 1 detects an amount (detected value d2) of displacement of the thumb of the operator from a position closer to the top face to the position closer to the back face on the right-side touch panel 14R or the left-side touch panel 14L, and increases the rate of turning pages with increasing a value of the detected value exceeding the threshold. This also makes the operator possible to continuously turn pages of an e-book, feeling as if reading an actual paper book.

Further, the right press sensor 15R and the left press sensor 15L detect a pressure that a finger of the operator applies, and increases the rate of turning pages with increasing a value of the detected value exceeding the threshold. This also makes the operator possible to continuously turn pages of an e-book, feeling as if reading an actual paper book.

If the acceleration sensor 16 (sensor S4) detects the acceleration in the direction towards the top face of the mobile terminal 1 exceeding the threshold s4, wherein the posture that the mobile terminal 1 is made into the reading holding state by the operator, the display controller 102 detects that the operator has flapped the mobile terminal 1. Upon detection of flapping by the operator, the display controller 102 turns a single page, making the operator feel as if reading an actual paper book.

The detection of thumb isolating, thumb shifting, and flapping is achieved by the right-side touch panel 14R, the left-side touch panel 14L, the right press sensor 15R, the left press sensor 15L, and the acceleration sensor 16. This can eliminate the requirement for dedicated movable parts to detect thumb isolating, thumb shifting, or flapping. Accordingly, it is possible to reduce the risk of failure, reducing the production costs.

(D) Others:

The present invention should by no means be limited to the above first embodiment, and various changes and modifications can be suggested without departing from the spirit of the present invention.

For example, in the first embodiment, the right-side touch panel 14R and the left-side touch panel 14L are regarded as the fore edges of a book and are used for detecting thumb isolating and thumb shifting by the operator. However, the present invention is not limited to this.

FIGS. 14A and 14B are partial isometric view illustrating an example of the right-side touch panel 14R on a mobile terminal 1 according to a modification to the first embodiment.

In the example of FIGS. 14A and 14B, images of a fore edge of a book are displayed on the right-side touch panel 14R. Likewise this alternative, the right-side touch panel 14R and the left-side touch panel 14L may display the images of the fore edges of a book.

In this display, the image of the fore edge may be changed using animation display with pages increased or decreased by turning pages.

FIG. 14A illustrates an image of a fore edge containing many pages on the right-side touch panel 14R; and FIG. 14B illustrates an image of a fore edge containing less pages on the right-side touch panel 14R.

This makes the operator of the mobile terminal 1 feel as if reading an actual paper book.

In the above first embodiment, the right press sensor 15R and the left press sensor 15L are disposed in the vicinity of the right and left short sides of the back face of the mobile terminal 1 in parallel with the short sides. However, the first embodiment is not limited to this.

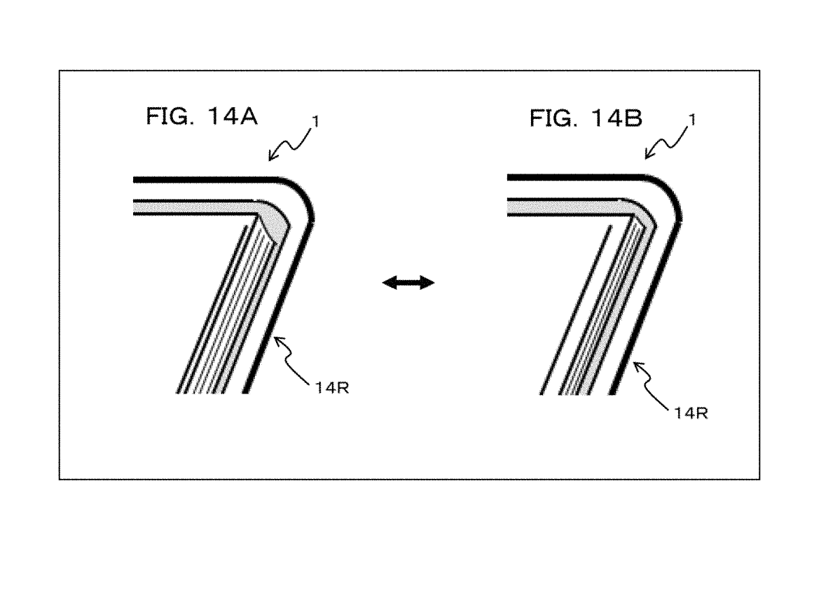

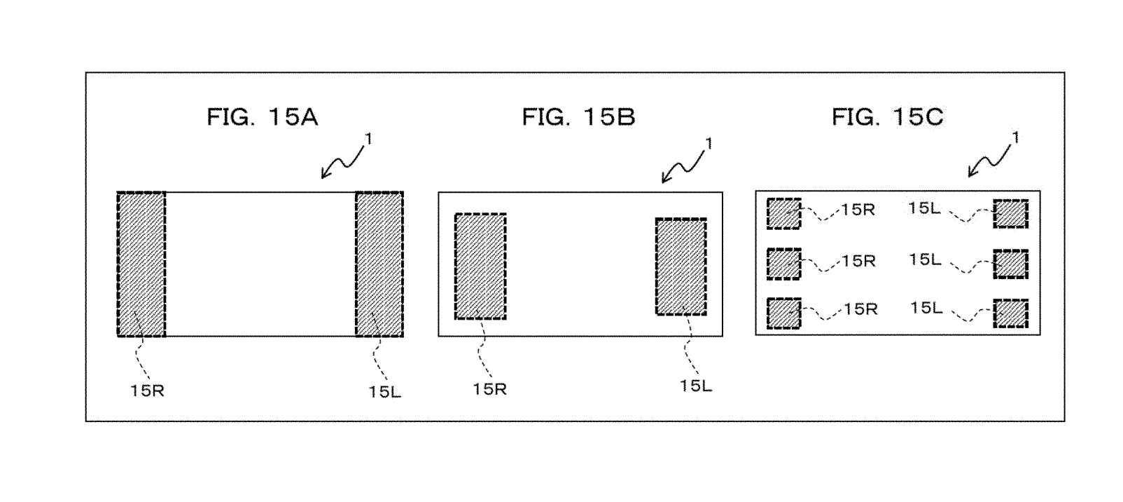

FIGS. 15A-15C are isometric views illustrating examples of the aspect of the back face of the mobile terminal 1 of a modification to the first embodiment.

The positions of thumbs and fingers touching the top and back covers are different with state and reader. Considering the above, as illustrated in FIGS. 15A-15C, the largeness and the positions of the right press sensor 15R and the left press sensor 15L may be appropriately changed.

Alternatively, a press sensor or a display containing a touch sensor may be arranged on the entire back face of the mobile terminal 1, and may achieve the function for the right press sensor 15R and the left press sensor 15L.

Each of the configurations and the functions of the device may be selected or omitted. For example, there is no need to use both thumb isolating and thumb shifting for an input for turning pages, and therefore, the pages may be turned on the basis of only one of these inputs.

The single-page turning of the mobile terminal 1 is not limited to being carried out in response to the inputs via the right-side touch panel 14R, the left-side touch panel 14L, the right press sensor 15R, the left press sensor 15L, and the acceleration sensor 16.

Alternatively, the display controller 102 may turn a page of an e-book in response to an input operation such as a flick input made by the operator touching the main touch panel 13 with a finger.

The display controller 102 may display a button, a slide bar, and/or a menu for turning pages on the main touch panel 13, and turn a page in response to an input operation that the operator made on the button, the slide bar, and/or the menu.

Those ordinarily skilled in the art can carry out and manufacture the foregoing embodiment with reference to the above disclosure.

According to the foregoing embodiment, the pages can be forwarded, making an operator feel as if reading an actual paper book.

All examples and conditional language recited herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An electronic-book reader device comprising:
a screen that displays a page image of an electronic book;
a first sensor that is disposed on a side face of the electronic-book reader device;
a second sensor that is disposed on a reverse face of the screen of the electronic-book reader device;
a determiner that determines a rate of switching display of a plurality of the page images using an amount of input operation via the first sensor and an amount of input operation via the second sensor; and
a display controller that carries out continuous page-turning display on the screen by displaying the plurality of page images being successively switched at the rate determined by the determiner.

2. The electronic-book reader device according to claim 1, wherein the determiner increases the rate with increasing of a pressure difference between a first pressure detected at a first position closer to the screen on the first sensor and a second pressure detected at a second position closer to the reverse face on the first sensor, the first pressure being lower than the second pressure.

3. The electronic-book reader device according to claim 1, wherein the determiner increases the rate with increasing of an amount of moving an article being in contact with the first sensor from a third position closer to the screen to a fourth position closer to the reverse face.

4. The electronic-book reader device according to claim 1, wherein the determiner increases the rate with increasing of a pressure detected by the second sensor.

5. The electronic-book reader device according to claim 1, further comprising a third sensor that detects an acceleration of the electronic-book reader device, wherein
when the acceleration detected by the third sensor exceeds a threshold while a value detected by the first sensor and a value detected by the second sensor do not satisfy a condition to start the continuous page-turning display and the continuous page-turning display is stopped,
the display controller carries out turning of a single page of the electronic-book by displaying the page image being switched by one page of the electronic book.

6. A non-transitory computer-readable recording medium having stored therein a program for display control causing a processor included in an electronic-book reader device to execute a process comprising:
displaying a page image of an electronic book;
determining a rate of switching display of a plurality of the page images using an amount of input operation via a first sensor that is disposed on a side face of the electronic-book reader device and an amount of input operation via a second sensor that is disposed on a reverse face of the screen of the electronic-book reader device; and
carrying out continuous page-turning display on the screen by displaying the plurality of page images being successively switched by at the determined rate.

7. The non-transitory computer-readable recording medium according to claim 6, the process further comprising:
increasing the rate with increasing of a pressure difference between a first pressure detected at a first position closer to the screen on the first sensor and a second pressure detected at a second position closer to the reverse face on the first sensor, the first pressure being lower than the second pressure.

8. The non-transitory computer-readable recording medium according to claim 6, the process further comprising:
increasing the rate with increasing of an amount of moving an article being in contact with the first sensor from a third position closer to the screen to a fourth position closer to the reverse face.

9. The non-transitory computer-readable recording medium according to claim 6, the process further comprising:
increasing the rate with increasing of a pressure detected by the second sensor.

10. The non-transitory computer-readable recording medium according to claim 6, the process further comprising:
when an acceleration detected by a third sensor that detects the acceleration of the electronic-book reader device exceeds a threshold while a value detected by the first sensor and a value detected by the second sensor do not satisfy a condition to start the continuous page-turning display and the continuous page-turning display is stopped,
carrying out turning of a single page of the electronic-book by displaying the page image being switched by one page of the electronic book.
